(19) United States
(12) Patent Application Publication
(10) Pub. No.: US 2003/0172046 A1
(43) Pub. Date: Sep. 11, 2003

(54) Method and system for managing systems as databases

(76) Inventor: Zachariah Scott, Calgary (CA)

Correspondence Address: KENYON & KENYON, ONE BROADWAY, NEW YORK, NY, 10004, US

(21) Appl. No.: 10/091,557

(22) Filed: Mar. 7, 2002

(51) Int. Cl. G06F 7/00

(52) U.S. Cl. 707/1

(57) ABSTRACT

A method and system for managing devices via a database application programming interface. The system receives a request for a database operation, and maps the request to at least one command for a non-database operation. The system may execute the at least one command by making a system call via a device API, or by making a remote procedure call to a device.

### BACKGROUND

Writing and maintaining configuration management software for networked devices can be a complicated, time-consuming and expensive process. To illustrate with a simple example, assume a network administrator needs a management tool to reboot a network switch. A fairly common solution is for a developer to create a custom Management Information Base (“MIB”) browser based on Simple Network Management Protocol (“SNMP”) standards. SNMP is a widely-used network monitoring and control protocol that uses MIB objects to communicate with and send commands to a device.

To continue with the example, the administrator runs the MIB browser on her workstation, and selects in the MIB browser the MIB object (representing the switch) for rebooting. Once selected, the administrator sets the value of the object to “1” (which is defined to cause the switch to reboot), and the network switch promptly reboots.

One problem with this development solution lies in its lack of flexibility. Because the SNMP protocol is fixed, the management tool does not support features such as good security (although a newer version of SNMP has added security), guaranteed (connection-based) delivery of data (because SNMP is a User Datagram Protocol (“UDP”) protocol), and transaction support (explained below). Including these features into a management tool adds to a developer's burden and complicates the development process.

Transaction support is a necessary feature for large-scale distributed enterprise applications, which commonly use and modify information stored in many separate databases. In Java®, the Enterprise Java Beans (“EJB™”) architecture is used to develop enterprise applications. Within any distributed application framework (like EJB™, Microsoft COM+, and CORBA®), Distributed Transaction Processing (“DTP”), such as the X/Open® DTP model, is required to ensure that operations are atomic, isolated, and durable, and that data remains consistent; this type of operation is referred to as ACID (Atomic, Consistent, Isolated, Durable).

Many database engines like Oracle®, Informix®, and MS SQL Server provide support for DTP and the execution of ACID operations. Within an EJB™ based enterprise application, data stored in databases is represented and accessed via Entity Beans. Entity Beans interact (store and retrieve data) with databases by using Java Database Connectivity (“JDBC®”) connections managed by the EJB™ Server. The EJB™ server maps the data in an Entity Bean to a record in a table in the database; each field in the Entity Bean maps to a field in the record. JDBC® provides the necessary services to the EJB™ server for database connection management and data management. It is the JDBC® driver's responsibility to support distributed transactions by representing the database as a distributed resource (e.g., via the Java® XAResource interface). A developer can greatly improve productivity by using Entity Beans in conjunction with DTP capable JDBC® drivers. This is common practice today in large-scale enterprise applications.

As discussed above, difficulty arises when attempting to manage systems that are not databases. Such management may include coordinating distributed ACID transactions among many non-database systems, such as Internet appliances, switches, routers, other small devices, network services, and networked application frameworks. Currently, a developer has to craft a custom management solution using Java® technologies like JTA and JTS (which support DTP), or a custom MIB browser may be written based on the above-mentioned SNMP standards.

Accordingly, there is a need in the art for a system and method that leverages existing database technologies to simplify the management of non-database systems.

### SUMMARY

The present invention is directed to a method and system for managing devices through the use of a database application programming interface (“API”). The present invention allows an application program to treat a device as if it were a relational database, through which database operation requests translate to actual device management commands.

In one example embodiment, the present invention provides this device management capability by receiving a request for a database operation, and mapping the request to at least one command for a non-database operation. The system may execute the at least one command by making a system call via a device API, or by making a remote procedure call to a device.

### BRIEF DESCRIPTION OF THE DRAWINGS

FIG. 1 is a block diagram of a computing arrangement in accordance with an exemplary embodiment of the present invention.

FIG. 2 is a block diagram that depicts a network architecture in accordance with an embodiment of the present invention.

FIG. 3 is flow chart that illustrates a process for managing a device via a database API in accordance with an embodiment of the present invention.

FIG. 4 is a block diagram that depicts a network architecture in accordance with an alternative embodiment of the present invention.

FIG. 5 is flow chart that illustrates a process for managing a device via a database API in accordance with an alternative embodiment of the present invention.

### DETAILED DESCRIPTION

### Infrastructure

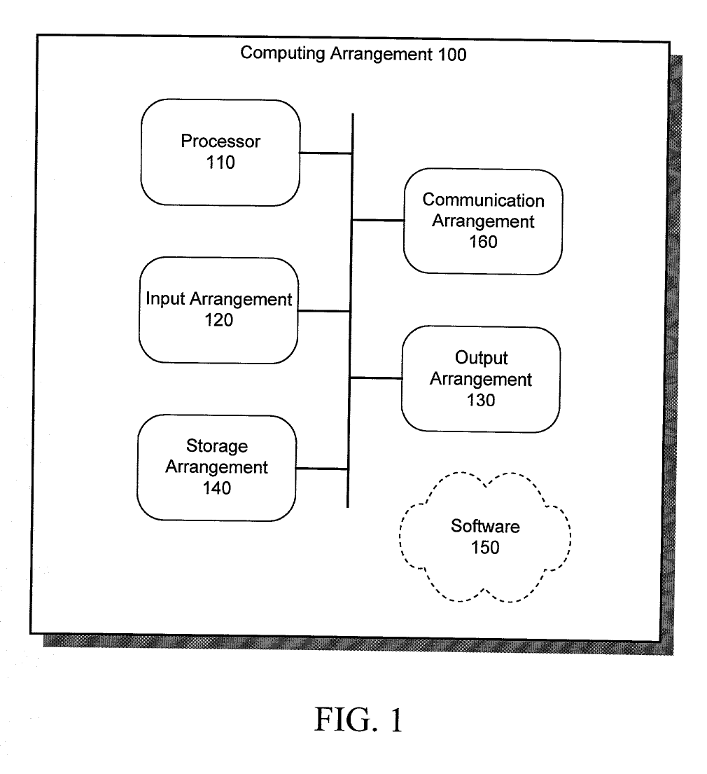

FIG. 1 is a block diagram depicting the internal structure of computing arrangement 100 in accordance with an exemplary embodiment of the present invention. Computing arrangement 100 may be an application server, personal computer, embedded system, or any other type of microprocessor-based device. Some examples of embedded systems include cellular telephones, pagers, web tablets, cable modems, home gateways, set-top boxes, industrial robots, programmable logic controllers, car infotainment and telematics devices. Computing arrangement 100 may include processor 110, input arrangement 120, output arrangement 130, storage arrangement 140, software 150 and communication arrangement 160.

Input arrangement 120 may include a keyboard, mouse, voice-recognition device, standard keypad (e.g., ITU-T phone keypad with buttons for the digits ‘0’ through ‘9’ and two more for ‘*’ and ‘#’, as used by some cell phones, or a reduced-size qwerty keyboard, as used by some pagers), non-standard keypad (e.g., key arrays with application-assigned functions, as used by ebook readers, web pads and tablets), touch pad (e.g., high-resolution and stylus-operated touch pads, as used by PDAs and point-of-sale terminals, and low-resolution and finger-touched pads, as used by ATMs), infrared device (e.g., TV remotes and infrared keyboards, as used by set-top boxes) or any other arrangement that provides input from a user.

Output arrangement 130 may include a monitor, LCD screen, TV, printer, disk drive, speakers, or any other arrangement that provides tangible output to user. Storage arrangement 140 may include volatile data storage, such as RAM, caches, or any storage medium that temporarily holds data while it is being processed, and nonvolatile data storage, such as a hard drive, CD-ROM drive, tape drive, removable storage disk, flash memory or any other non-temporary storage medium.

Communication arrangement 160 may include a modem, network interface card, wireless communication facility, or any other network interface or arrangement capable of transmitting and receiving signals over a network. The networking may be carried over serial, phone or cable lines, or may be wireless, and may include any communication protocol, such as TCP/IP.

Software 150 may reside in storage arrangement 140, and may include application software, system software, middleware, or any other programming that provides instructions to processor 110 to perform the intended tasks of computing arrangement 100. Software 150 may be written in any programming language, such as Java(t, C, and C++.

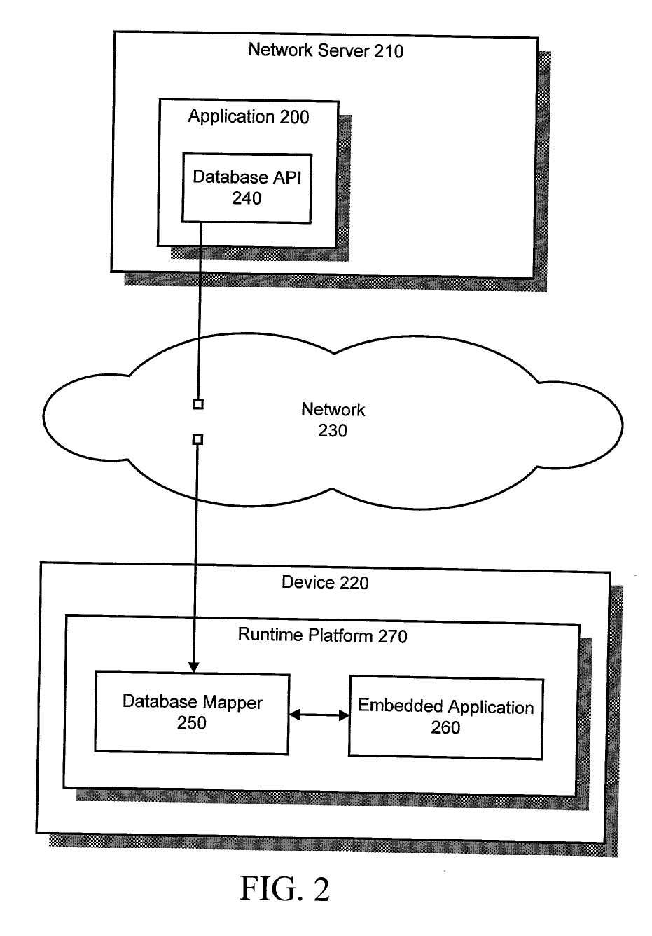

FIG. 2 depicts a network architecture in accordance with an example embodiment of the present invention. In this embodiment, application 200, running on network server 210, communicates with device 220 across network 230 via database API 240. Device 220, which is operated by embedded application 260 via runtime platform 270, receives communications from database API 240 through database mapper 250.

Network server 210 and device 220 are computing arrangements, for example, as shown by computing arrangement 100 (although device 220 may not have input arrangement 120 and output arrangement 130). Application 200, database API 240, runtime platform 270, database mapper 250, and embedded application 260 are software as shown by software 150, but may be implemented as hardware (in whole or in part).

Application 200 may include, among others, a software management tool to be used by a network administrator to manage device 220, or an EJB™ based enterprise application, as mentioned above. Database API 240 may be a standard database driver, as known in the art, such as a JDBC® or ODBC (Open Database Connectivity) driver. Runtime platform 270 may be any runtime platform capable of networking, such as real-time operating systems pSOS® or VxWorks®, both available from Wind River Systems, Inc., Alameda, Calif., UNIX®-like platforms such as BSD®, also available from Wind River Systems, Inc., and other comparable embedded platforms. (Similary, network server 210 may also be run by any platform capable of networking, such as a UNIX®-like platform). Embedded application 260 may include embedded application software to be used for local management of device 220. A bytecode processing facility, such as a Java® virtual machine, may be included in runtime platform 270.

Database mapper 250 includes software to map database operation requests from database API 240 to commands for non-database operations to be executed by runtime platform 270, in accordance with an embodiment of the present invention. It should be noted that one skilled in the art would appreciate that database mapper 250 could reside in device 220 as a software or hardware module apart from embedded application 260, or it could be part of embedded application 260. Database mapper 250 may be implemented in any programming language, and if implemented in Java® may be executed via the bytecode processing facility of runtime platform 270.

Network 230 may include, among others, a wide-area network (“WAN”), such as the Internet, or a local-area network (“LAN”), such as an intranet. The network link may include telephone lines, DSL, cable networks, T1 or T3 lines, wireless network connections, or any other arrangement that provides a medium for the transmission and reception of network signals. It should be noted that, technically, network server 210, device 220 and any intermediate network components, such as Internet service providers and routers (not shown), are also part of network 230 because of their connectivity. Network 230 may implement any number of communications protocols, including TCP/IP (“Transmission Control Protocol/Internet Protocol”) or UDP/IP. Communications may be secured by any Internet security protocol, such as Secured Sockets Layer (“SSL”).

### Device Embodiment

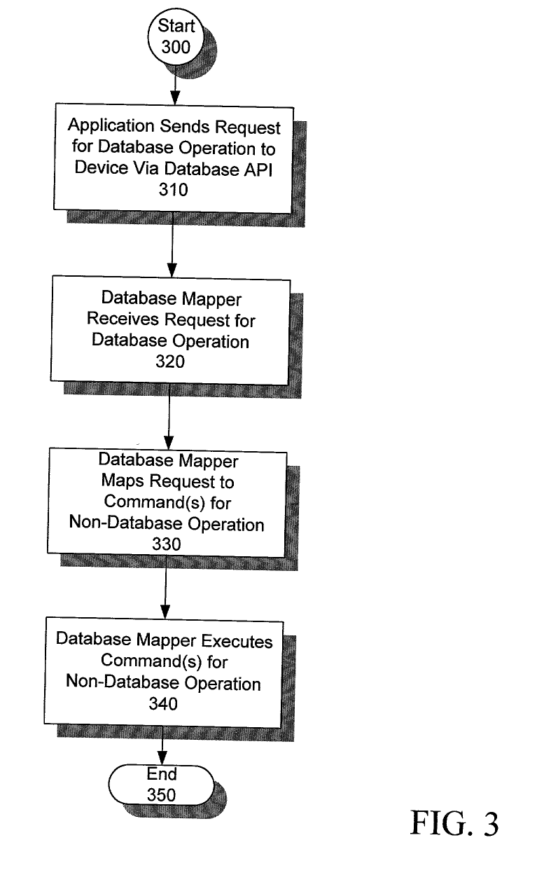

FIG. 3 depicts a process for managing device 220 via database API 240 in accordance with an example embodiment of the present invention. For purposes of illustration and continuity, this embodiment details a network administrator rebooting a switch (device 220) via a JDBC® driver (database API 240).

The process starts (step 300) when the network administrator runs a management tool (application 200) on her workstation. Through the management tool interface, the administrator selects database table “Switch” (which corresponds to device 220), selects a database field for “power_state,” and sets the value for that database field to “REBOOT.”

In step 310, the management tool, upon receiving this action from the administrator through the management tool interface, loads the appropriate JDBC® driver, establishes a connection to the remote database (which in reality is database mapper 250), and sends to the remote database a request for a database operation such as:

UPDATE Switch
SET power_state = ‘REBOOT’

This SQL statement is a database instruction to place the string “REBOOT” into the column “power_state” of table “Switch.”

Because database mapper 250 represents itself outside of device 220 as a relational database, the JDBC® driver is therefore able to interface with database mapper 250 in the same manner that it would interface with any other supported database platform, such as Oracle®, Informix®, and MS SQL Server. To support a database platform, the developer of the JDBC® driver makes certain that the database platform's interface, or in this case, database mapper 250's interface, is in compliance with the JDBC® API. No additional modification of the database driver is required in this embodiment, beyond ensuring its compliance with the appropriate database protocols.

Database mapper 250 receives the request for a database operation (step 320) through its platform interface, and then maps the request to a command or commands for a non-database operation (step 330). Continuing the current example, database mapper 250 includes programming logic that deciphers the incoming SQL request in order to identify the appropriate device and action to be taken. From the identification of the table name (“Switch”), column name (“power_state”) and update value (“REBOOT”) of the incoming request, database mapper knows to execute stored commands for rebooting the network switch. The stored commands may reside in the software of database mapper 250 itself, or may be referenced in local or remote data files.

In step 340, database mapper 250 executes the identified commands. This may happen in any number of ways, depending on the relationship between database mapper 250 and embedded application 260. If database mapper 250 is part of embedded application 260, the commands to be executed may involve local system calls to the device API. If database mapper 250 is separate from embedded application 260, the commands to be executed may involve a remote procedure call to the device, which could be accomplished by using Remote Invocation Method (“RMI”), a Java® version of Remote Procedure Call (“RPC”) with additional functionality. The commands may involve any non-database operation, such as managing configurations, software installations and running processes. The process of FIG. 3 ends (step 350) upon execution of the identified commands.

### Driver Embodiment

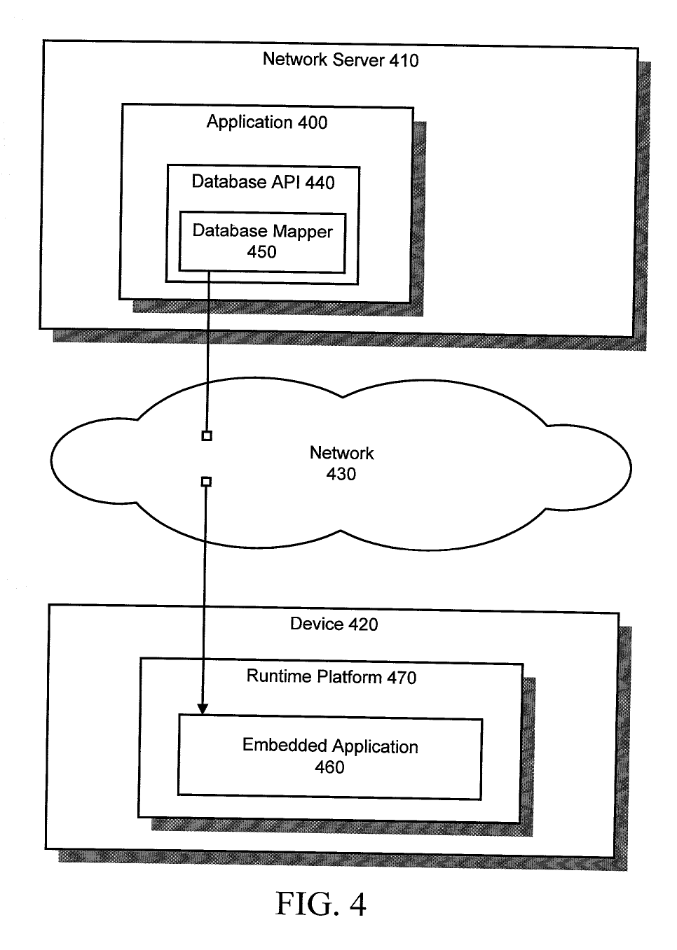

FIG. 4 depicts a network architecture in accordance with an alternative embodiment of the present invention. This alternative embodiment is similar to the embodiment depicted in FIG. 2, except that database mapper 450 is part of database API 440 instead of device 420. Except for this change, network server 410 mirrors network server 210 in structure and functionality, as does application 400 with respect to application 200, network 430 with respect to network 230, device 420 with respect to device 220, runtime platform 470 with respect to runtime platform 270, and embedded application 460 with respect to embedded application 260. Network server 410 may further include a bytecode processing facility to facilitate the execution of, for example, database mapper 450 (if needed).

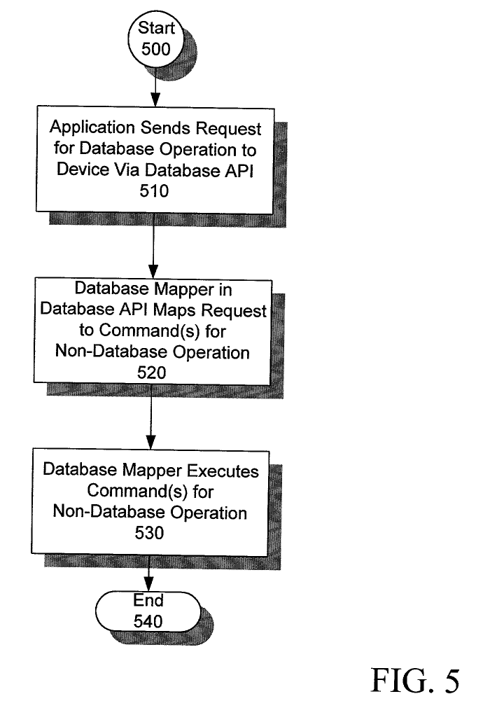

FIG. 5 depicts a process for managing device 420 via database API 440 in accordance with this alternative embodiment of the present invention. In step 510 (and in the same manner as discussed in step 310), the management tool (application 400) sends a request for a database operation to the switch (device 420) via a JDBC® driver (database API 440).

In step 520, however, the database mapper 450 performs its mapping function (as described in step 330) locally, since database mapper 450 resides in the JDBC® driver (database API 440) in this alternative embodiment. Then in step 530, the database mapper 450 executes the mapped REBOOT command by sending a remote procedure call to the switch across the network (step 540).

Thus, in this embodiment, the developer of the JDBC® driver needs to include database mapper 450 into the driver, but the management tool and the switch require no additional modification. The management tool is interfacing with the switch via the database driver as if the switch were a database, and the switch is interfacing with the management tool as it would expect to interface with any device management application.

### Other Embodiments

It should be noted that the above example pertaining to rebooting a network switch is a simple illustration of one possible embodiment of the present invention. For a more detailed example embodiment, Chart 1 below provides a mapping schema that illustrates a relationship between requests (e.g., SQL) for a database operation and their associated commands for non-database operations:

CHART 1

| SQL Command | Database Operation | Non-Database Operation |
|---|---|---|
| INSERT | Adds a row to a table. | Add a static route; install a software component; |
| | | add a user to the access control list; add a filter to |
| | | the logging utility. |
| UPDATE | Updates information | Perform a reboot; sleep; change password; trigger |
| | in a table. | alarm; lock-out a specific user account; |
| | | start/stop/restart a specific software component. |
| DELETE | Deletes a row from a | Remove an authentication account; remove a static |
| | table. | route; remove installed software component. |
| SELECT | Fetches information | Get list of users that are currently logged in; get all |
| | stored in a table. | static route entries; get currently running software |
| | | components. |

With respect to Chart 1, the information added from an “insert” command could specify an operation or configuration that directly and immediately impacts the configuration or state of the device being managed. The information updated from an “update” command could update and directly impact device state. The information deleted from a “delete” command could remove a configuration item from the system, and the information retrieved from a “select” command could get data that describes the current state of the device, not from an inert data-store but directly from the running system.

In another embodiment, application 200 may additionally include software performing a reverse-mapping of the mapping functionality provided by database mapper 250. For example, in the embodiment above pertaining to a network administrator rebooting a switch, application 200 was a management tool that provided a database interface to the administrator. In this embodiment, application 200 could be a management tool with a similar user interface to other such network tools in the field (such as a MIB browser). When the administrator selects the appropriate switch to be rebooted, application 200 performs an initial mapping of the command for a non-database operation (i.e., to reboot) to the appropriate request for database operation (see step 310 above). The embodiment proceeds as described above after this point. This reverse mapping process could similarly be implemented in an EJB™ based enterprise application.

Several embodiments of the present invention are specifically illustrated and/or described herein. However, it will be appreciated that modifications and variations of the present invention are covered by the above teachings and within the purview of the appended claims without departing from the spirit and intended scope of the present invention. For example, the present invention does not have to communicate across a network, and the recipient of the commands does not have to be a physical device.

What is claimed is:

1. A method for managing a device, comprising:
a) receiving a request for a database operation; and
b) mapping the request to at least one command for a non-database operation.

2. The method of claim 1, wherein the request for a database operation is received from a database driver.

3. The method of claim 2, wherein the database driver in one of a JDBC® driver and an ODBC driver.

4. The method of claim 1, further including executing the at least one command.

5. The method of claim 4, wherein the execution of the at least one command includes making a system call via a device API.

6. The method of claim 4, wherein the execution of the at least one command includes making a remote procedure call.

7. The method of claim 1, wherein the non-database operation includes at least one of adding a static route, installing a software component, adding a user to the access control list, adding a filter to the logging utility, performing a reboot, sleeping, changing a password, triggering an alarm, locking-out a specific user account, starting/stopping/restarting a specific software component, removing an authentication account, removing a static route, removing an installed software component, getting a list of users that are currently logged in, getting all static route entries, and getting currently running software components.

8. The method of claim 1, wherein the request for a database operation is an SQL query.

9. A system comprising:
an application having at least one command for a non-database operation; and
a database mapper facility adapted to receive a request for a database operation, the database mapper facility further adapted to map the request to the at least one command.

10. The system of claim 9, further comprising a database driver, wherein the database mapper facility receives the request for a database operation from the database driver.

11. The system of claim 10, wherein the database driver in one of a JDBC® driver and an ODBC driver.

12. The system of claim 9, wherein the database mapper facility is further adapted to execute the at least one command.

13. The system of claim 12, wherein the execution of the at least one command includes making a system call via a device API.

14. The system of claim 12, wherein the execution of the at least one command includes making a remote procedure call to a device.

15. The system of claim 9, wherein the non-database operation includes at least one of adding a static route, installing a software component, adding a user to the access control list, adding a filter to the logging utility, performing a reboot, sleeping, changing a password, triggering an alarm, locking-out a specific user account, starting/stopping/restarting a specific software component, removing an authentication account, removing a static route, removing an installed software component, getting a list of users that are currently logged in, getting all static route entries, and getting currently running software components.

16. The system of claim 9, wherein the request for a database operation is an SQL query.

17. A machine-readable medium storing instructions adapted to be executed by a processor to:
a) receive a request for a database operation; and
b) map the request to at least one command for a non-database operation.

18. The medium of claim 17, the stored instructions further adapted to be executed by a processor to execute the at least one command.

19. An apparatus for managing devices, comprising:
a) means for receiving a database operation request;
b) means for translating the database operation request to a non-database system call; and
c) means for executing the non-database system call.

20. A method for managing devices, comprising:
a) receiving a command for a non-database operation;
b) mapping the command to at least one request for a database operation;
c) sending the at least one request through a database driver;
d) receiving the sent at least one request; and
e) mapping the received at least one request to the command for a non-database operation.

21. The method of claim 20, wherein the non-database operation includes at least one of adding a static route, installing a software component, adding a user to the access control list, adding a filter to the logging utility, performing a reboot, sleeping, changing a password, triggering an alarm, locking-out a specific user account, starting/stopping/restarting a specific software component, removing an authentication account, removing a static route, removing an installed software component, getting a list of users that are currently logged in, getting all static route entries, and getting currently running software components.

22. A system comprising:
a database driver;
a software management tool; and
a database mapper facility;
wherein the software management tool is adapted to receive a command for a non-database operation, the software management tool further adapted to map the command to at least one request for a database operation, the management tool further adapted to send the at least one request through the database driver, and
wherein the database mapper facility is adapted to receive the sent at least one request, the database mapper facility further adapted to map the received at least one request to the command for a non-database operation.

23. The system of claim 22, wherein the non-database operation includes at least one of adding a static route, installing a software component, adding a user to the access control list, adding a filter to the logging utility, performing a reboot, sleeping, changing a password, triggering an alarm, locking-out a specific user account, starting/stopping/restarting a specific software component, removing an authentication account, removing a static route, removing an installed software component, getting a list of users that are currently logged in, getting all static route entries, and getting currently running software components.
